(19) United States
(12) Patent Application Publication
(10) Pub. No.: US 2010/0315933 A1
(43) Pub. Date: Dec. 16, 2010

(54) OPTICAL PICKUP DEVICE AND TEMPERATURE CHARACTERISTICS CORRECTION METHOD FOR OBJECT LENS

(76) Inventor: Toshio IWAMI, Osaka (JP)

Correspondence Address: MORGAN LEWIS & BOCKIUS LLP, 1111 PENNSYLVANIA AVENUE NW, WASHINGTON, DC, 20004, US

(21) Appl. No.: 12/797,935

(22) Filed: Jun. 10, 2010

(30) Foreign Application Priority Data
Jun. 11, 2009 (JP) 2009-139720

(51) Int. Cl. G11B 7/135

(52) U.S. Cl. 369/112.23; G9B/7.112

(57) ABSTRACT

In an optical pickup device 1 and a temperature characteristics correction method for an object lens, structure is employed in which a prescribed temperature recognition operation is performed on temperature information detected by a thermistor 16, temperature of the object lens 7 is recognized, temperature characteristics of the lens is corrected, and the structure includes a temperature recognition operation waiting function that the temperature recognition operation is held waiting for a predetermined time period L1 defined in advance, and the temperature recognition operation is started after the predetermined time period has elapsed, therefore, the optical pickup device and the temperature characteristics correction method do not generate insufficient correction or excessive correction and proper temperature characteristics correction is made possible when the temperature characteristics of the object lens is corrected by recognizing temperature of the object lens utilizing the thermistor arranged on a driving circuit board on which heat generating parts of the optical pickup device are arranged.

This application is based on Japanese Patent Application No. 2009-139720 filed on Jun. 11, 2009, and the contents of which are hereby incorporated by reference.

### BACKGROUND OF THE INVENTION

1. Field of the Invention

The present invention relates to an optical pickup device which performs recording or reproducing of data by irradiating an optical disc with laser light and a temperature characteristics correction method for an object lens.

2. Description of Related Art

From the past, many kinds of optical disc such as a Compact Disc (CD), a Digital Versatile Disc (DVD), a High-Definition Digital Versatile Disc (HD-DVD), and a Blu-ray Disc, is made practical as a disc shaped recording medium. In these many kinds of optical discs, one or a plurality of object lens are used for compatibility with the plurality kinds of optical discs because wavelength of utilized laser light and depth of a transparent layer to a recording surface are different.

On the other hand, an optical pickup device which performs recording or reproducing of data by irradiating an optical disc with laser light is used. The optical pickup device is provided with an object lens to focus the laser light as a spot on signal recording layer of the optical disc. Conventionally this object lens has been made from glass material. However, because the object lens made from glass material is expensive and having large specific gravity, it is not advantageous to increase response characteristics of the optical pickup. On the contrarily, when the object lens is made from a resin material, cost of the lens can be drastically reduced in comparison with a case when it is made from the glass material. Further, because the specific gravity of the resin material is about one half of that of the glass material, weight saving of the object lens can be realized and high response thereof is expectable.

However, on the other hand, because the object lens made from the resin material is apt to change its optical characteristics due to temperature in comparison with the object lens made from the glass material, when numerical aperture of the object lens is increased in accordance with developing of high density optical disc, change in the optical characteristics of the object lens affects recording and reproducing characteristics.

Because of this, an invention of optical head has been filed and opened to public already in which a temperature sensor is embedded in a lens holder to detect temperature of the object lens and temperature around the object lens is detected to perform prescribed aberration correction (For example, patent document JP-A-2005-18924).

Further, it has been put in force that temperature of the optical disc is recognized utilizing a non contact type temperature sensor and an invention of recording and reproducing method has been filed and opened to public already in which control of the laser light is performed to control output of the laser light suitable for temperature of the optical disc (For example, patent document JP-A-H09-265651).

Still further, an invention of optical disc apparatus has been filed and opened to public already in which a thermistor is utilized to detect temperature around a laser diode to increase control accuracy of light emitting power of the laser diode by an assignee of the present invention (For example, patent document JP-A-2006-338701).

In order to make the laser light focus on the signal recording layer of the optical disc as a spot utilizing a laser diode and an object lens, it is essential that the control accuracy of light emitting power of the laser diode is increased by detecting temperature around the laser diode, and a prescribed correction (temperature characteristics correction) is performed to correct temperature characteristics which changes in response to temperature of the object lens by detecting temperature of the object lens.

Further, in the optical pickup device which is provided with the thermistor on a driving circuit board to detect temperature around the laser diode, in addition to this thermistor to provide another temperature sensor to detect temperature of the object lens, causes cost thereof up. Because of this, it is preferable that to recognize temperature of the object lens utilizing the thermistor provided on the driving circuit board.

However, in the method to recognize temperature of the object lens utilizing the thermistor provided on the driving circuit board, and to perform correction of temperature characteristics, it causes a problem that insufficient correction or excessive correction is generated because of abrupt change of temperature from when operation is begun by heat generating parts around the circuit board on which the thermistor is arranged, or influence of temperature difference between the thermistor portion and the object lens portion.

Due to this problem, it has been long required a temperature characteristics correction method for the object lens by which temperature of the object lens is correctly recognized, appropriate correction of temperature characteristics is made possible, and the insufficient correction or the excessive correction is not generated when temperature of the object lens is recognized from detected temperature of the thermistor arranged on the driving circuit board, and the temperature characteristics which changes in response to temperature of the object lens, is corrected.

### SUMMARY OF THE INVENTION

The present invention is made with reference to above described problem, and an object of the present invention is to provide an optical pickup device and a temperature characteristics correction method for an object lens by which the insufficient correction or the excessive correction is not generated and appropriate correction of temperature characteristics is made possible, when temperature of the object lens is recognized utilizing a thermistor which is arranged on a driving circuit board provided with heat generating parts of the optical pickup device, and the temperature characteristics of the object lens which changes in response to temperature of the object lens, is corrected.

To attain the above described object, an optical pickup device according to the present invention includes: a circuit board; a laser diode, a laser diode driving circuit and a thermistor that are mounted on the circuit board; and a control portion that has a control function to perform recording or reproducing of data by irradiating an optical disc with laser light and controlling light output of the laser diode based on temperature information detected by the thermistor, and it is characterized in that the optical pickup device has a temperature recognition function which performs a temperature recognition operation to recognize temperature of the object lens from the temperature information detected by the thermistor, a temperature characteristics correction function to correct temperature characteristics of the lens from the recognized temperature of the object lens, and a temperature recognition operation waiting function not to start the temperature recognition operation for a predetermined time period defined in advance.

According to this structure, when driving of the optical pickup device is started, temperature detected by the thermistor becomes increased by heat generation of the heat generating parts such as the laser diode, the laser diode driving circuit, and the like, those become heated gradually in connection with starting of the system operation, the device is configured such that temperature recognition operation to recognize temperature of the object lens is not performed for the predetermined time period defined in advance, and the temperature recognition operation can be started to recognize temperature of the object lens about a time point when temperature information detected by the thermistor and temperature of the object lens reach the saturation temperature and the system becomes stable. As a result, it is made possible to recognize accurately temperature of the object lens and to perform properly correction of temperature characteristics which varies in response to temperature of the object lens, the optical pickup device can be realized in which the insufficient correction or the excessive correction is not generated.

Further, the present invention is characterized in that in the optical pickup device having structure as above described, the predetermined time period is a time period that is defined in advance from starting of the system operation of the optical pickup device, and the temperature recognition operation waiting function includes a function to hold waiting the temperature recognition operation for the predetermined time period, and a function to permit starting of the temperature recognition operation after the predetermined time period has elapsed, and the temperature recognition operation waiting function is performed such that the temperature recognition operation is held waiting until it is confirmed that the predetermined time period has elapsed. According to this structure, the optical device is operated such that temperature characteristics correction for the object lens is not performed till the predetermined time period has elapsed, and the prescribed temperature recognition operation is started to recognize temperature of the object lens and temperature characteristics correction for the object lens is started about a time point when the system reaches the saturation temperature and becomes stable. As a result, it is made possible to recognize accurately temperature of the object lens and to perform properly correction of temperature characteristics which varies in response to temperature of the object lens, the optical pickup device can be realized in which the insufficient correction or the excessive correction is not generated.

Still further, the present invention is characterized in that in the optical pickup device having structure as above described, the predetermined time period is a time period that is variation rate of temperature detected by the thermistor becomes lower than variation rate to start the temperature recognition defined in advance, and the temperature recognition operation waiting function includes a function to measure variation rate of temperature detected by the thermistor, and a function to define in advance variation rate to start the temperature recognition operation, and the temperature recognition operation waiting function is performed such that the temperature recognition operation is not started till the measured rate of the temperature variation becomes lower than the variation rate to start the temperature recognition defined in advance. According to this structure, the prescribed temperature recognition operation is started after variation rate of the thermistor becomes lower than variation rate to start the temperature recognition defined in advance, that is, after temperature of the thermistor substantially reaches saturation temperature. As a result, the prescribed temperature recognition operation is started to recognize accurately temperature of the object lens and to perform properly correction of temperature characteristics which varies in response to temperature of the object lens about a time point when the system reaches the saturation temperature and becomes stable, the optical pickup device can be realized in which the insufficient correction or the excessive correction is not generated.

Still further, the present invention is characterized in that in the optical pickup device having structure as above described, the temperature recognition operation waiting function includes a function to measure variation rate of temperature detected by the thermistor, a function not to start the temperature recognition operation till the measured variation rate of temperature becomes lower than variation rate to start the temperature recognition operation defined in advance, and a function to hold waiting the temperature recognition operation for a predetermined time period defined in advance from starting of the system operation of the optical pickup device, and wherein the predetermined time period is a time period that the rate of temperature variation becomes lower than variation rate to start the temperature recognition defined in advance, and at the same time the predetermined time period defined in advance has lapsed. According to this structure, even in a state where variation rate of the thermistor becomes lower than variation rate to start the temperature recognition defined in advance, the temperature recognition operation is not started if the predetermined time period has not elapsed, and the correction of temperature characteristics is not performed. As a result, optical pickup device is realized in which the insufficient correction or the excessive correction is not generated and more stable correction of temperature characteristics is made possible.

To attain the above described object, a temperature characteristics correction method for an object lens according to the present invention is applicable to an optical pickup device including: a circuit board; a laser diode, a laser diode driving circuit and a thermistor that are mounted on the circuit board; and a control portion that has a control function to perform recording or reproducing of data by irradiating an optical disc with laser light and controlling light output of the laser diode based on temperature information detected by the thermistor, and the temperature characteristics correction method includes: a temperature recognition function which performs a temperature recognition operation to recognize temperature of the object lens from the temperature information detected by the thermistor, a temperature characteristics correction function to correct temperature characteristics of the lens from the recognized temperature of the object lens, and a temperature recognition operation waiting function not to start the temperature recognition operation for a predetermined time period defined in advance, and the method is characterized in that the method is performed such that the temperature recognition operation is held waiting for the predetermined time period defined in advance from starting of the system operation of the optical pickup device, and the temperature recognition operation is started after the predetermined time period has lapsed.

According to this structure, when driving of the optical pickup device is started, the temperature information of the thermistor becomes increased by heat generation of the heat generating parts such as the laser diode, the laser diode driving circuit, and the like, those become heated gradually in connection with starting of the system operation, the method is configured such that the prescribed temperature recognition operation to recognize temperature of the object lens is started after the predetermined time period defined in advance has elapsed, the correction of temperature characteristics is not performed till the predetermined time period has elapsed, and the prescribed temperature recognition operation is started about a time point when the system reaches the saturation temperature and becomes stable to start temperature characteristics correction for the object lens. As a result, it is made possible to perform properly correction of temperature characteristics which varies in response to temperature of the object lens, the temperature characteristics correction method can be realized in which the insufficient correction or the excessive correction is not generated.

Further, a temperature characteristics correction method for an object lens according to the present invention is applicable to an optical pickup device including:
a circuit board; a laser diode, a laser diode driving circuit and a thermistor that are mounted on the circuit board; and a control portion that has a control function to perform recording or reproducing of data by irradiating an optical disc with laser light and controlling light output of the laser diode based on temperature information detected by the thermistor, the temperature characteristics correction method includes: a temperature recognition function which performs a temperature recognition operation to recognize temperature of the object lens from the temperature information detected by the thermistor, and a temperature characteristics correction function to correct temperature characteristics of the lens from recognized temperature of the object lens, and the temperature characteristics correction method further includes: a temperature recognition operation waiting function having a function to measure variation rate of temperature detected by the thermistor and a function to define in advance rate of temperature variation to start the temperature recognition operation, and the method is characterized by that the method is performed such that the temperature recognition operation is started after that rate of temperature variation detected by the thermistor becomes lower than the rate of temperature variation to start the temperature recognition operation defined in advance, is detected.

According to this structure, the prescribed temperature recognition operation is started after it is confirmed that variation rate detected through the thermistor becomes lower than variation rate to start the temperature recognition defined in advance, that is, after temperature of the thermistor substantially reaches the saturation temperature to recognize temperature of the object lens and to start the temperature characteristics correction for the object lens. As a result, the temperature characteristics correction method for the object lens is realized in which the insufficient correction or the excessive correction is not generated and proper correction of temperature characteristics is made possible.

Further, the present invention is characterized in that in the temperature characteristics correction method for an object lens having structure as above described, the temperature recognition operation waiting function further includes a function not to start the temperature recognition operation for a predetermined time period defined in advance, and the method is performed such that the temperature recognition operation is held waiting for the predetermined time period defined in advance from starting of system operation of the pickup device, starting of the temperature recognition operation is permitted after the predetermined time period has elapsed, and the temperature recognition operation is not performed within the predetermined time period defined in advance even in a state where the rate of temperature variation becomes lower than the variation rate to start the temperature recognition defined in advance. According to this structure, even when it is confirmed that rate of temperature variation detected through the thermistor becomes lower than the variation rate to start the temperature recognition defined in advance, the temperature recognition operation is not started if the predetermined time period has not elapsed. As a result, it is preferable that the temperature characteristics correction method for an object lens is realized in which the insufficient correction or the excessive correction is not generated, and more stable temperature characteristics correction is made possible.

Still further, the present invention is characterized in that in the temperature characteristics correction method for an object lens having structure as above described, the variation rate to start the temperature recognition is 1 degree C./30 seconds. According to this structure, stable correction of the temperature characteristics is made possible in which the insufficient correction or the excessive correction is not generated without waste of time because the temperature recognition operation of the object lens is started and the correction of temperature characteristics is performed at an early time point when raise level of temperature becomes the temperature variation rate of about 1 degree C./30 seconds and the system comes closer to substantial saturation state, it is conceivable that the system reaches the saturation temperature, though ambient temperature of vicinity where the thermistor is arranged is raised violently due to the heat generating parts such as the laser diode, the laser driving circuit, and the like which make heat violently after starting of the system operation of the optical pickup device.

### BRIEF DESCRIPTION OF THE DRAWINGS

FIG. 1 is a schematic explanatory diagram to show one example of structure of an optical pickup device according to the present invention.

FIG. 2 is a schematic diagram to show a general outline of temperature variation.

FIG. 3 is a graph to show actual result of measurement of temperature of various portions.

FIG. 4 is a flowchart of first embodiment of a temperature characteristics correction method for an object lens according to present invention.

FIG. 5 is a flowchart of second embodiment of a temperature characteristics correction method for an object lens according to present invention.

FIG. 6 is a flowchart of third embodiment of a temperature characteristics correction method for an object lens according to present invention.

### DETAILED DESCRIPTION OF PREFERRED EMBODIMENTS

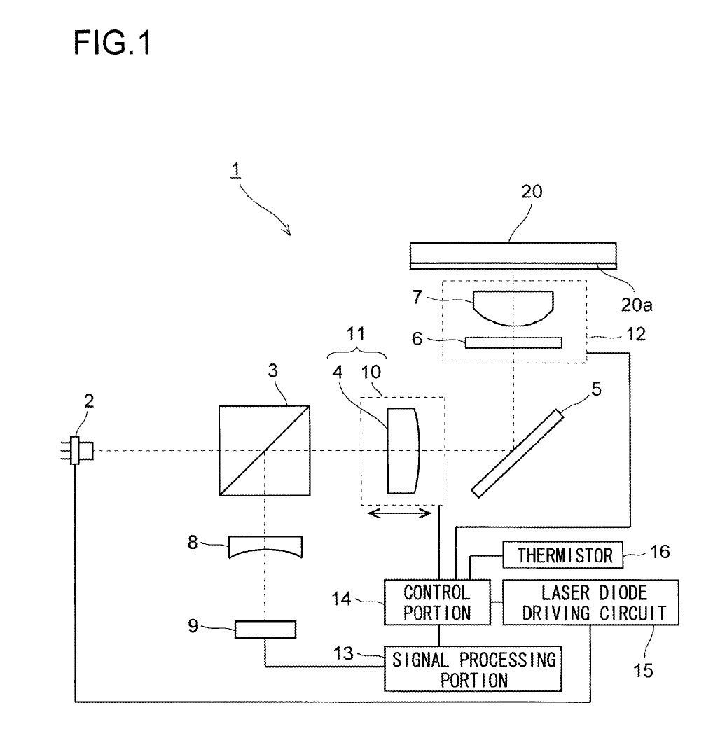

Hereinafter, embodiments of the present invention will be explained with reference to attached drawings. First, an explanation about an optical pickup device will be given by means of FIG. 1.

The optical pickup device 1 according to the present embodiment is a device which performs recording or reproducing of data by irradiating an optical disc with laser light, for example, as shown in FIG. 1, the device includes: a laser diode 2 that is a laser light source; polarization beam splitter 3; a collimator lens 4; a deflecting mirror 5; a quarter wave plate 6; an object lens 7; a cylindrical lens 8; and a photo detector 9, and focuses the laser light on a recording surface 20a of an optical disc 20 utilizing the object lens 7.

The laser diode 2 is a semiconductor laser which emits a laser light with a prescribed wavelength, and it is selected in compliance with kind of the optical disc 20. Further, though the device is depicted as an optical pickup device 1 which is provided with only one laser diode 2 compatible with only one kind of the optical disc 20, it is no problem that the optical pickup device is a device provided with a plurality of laser diodes 2 compatible with a plurality kinds of optical discs 20.

The polarization beam splitter 3 has a function by that one of two linear polarized light which cross at right angle with each other, is passed and other linear polarized light is reflected, in order to pass the laser light which is emitted by the laser diode 2 and to reflect the laser light which is reflected by the optical disc 20 to the photo detector 9. The photo detector 9 converts light information included in the received laser light to an electric signal.

The collimator lens 4 has a function to convert input laser light to parallel light. Further, the collimator lens 4 constitutes a spherical aberration correcting mechanism 11 by building the collimator lens 4 in a collimator lens driving unit 10 and making the collimator lens 4 movable along a light axis direction, in order to make a convergence or divergence state of the laser light controllable which passes the collimator lens 4.

The deflecting mirror 5 reflects the laser light output from the collimator lens 4 to the optical disc 20. Further, the quarter wave plate 6 has a function to convert the linear polarized light into a circular polarized light and to convert the circular polarized light into the linear polarized light, in order to convert the circular laser light which is reflected by the optical disc 20 into the linear polarized light, which is output from the deflecting mirror 5 to the collimator lens 4.

The object lens 7 focuses the laser light to irradiate a recording surface 20a of the optical disc 20 and receives the laser light reflected by the recording surface 20a to output to the quarter wave plate 6.

The object lens 7 has a function to focus the laser light as a spot on the recording surface 20a of the optical disc 20, and it is preferable to employ a plastic lens that is lighter in weight in comparison with a glass lens and is cheaper in cost because it is suitable for mass-production.

Further in this embodiment, for example, the object lens 7 and the quarter wave plate 6 are both arranged on an actuator 12 to make them movable in a focusing direction and a tracking direction.

The cylindrical lens 8 has a function to give astigmatism to the laser light reflected by the recording surface 20a of the optical disc 20 and the astigmatism can be utilized to detect focus error.

The electric signal output from the photo detector 9 is sent to a signal processing portion 13. The signal processing portion 13 processes the received electric signal from the photo detector 9 to generate RF signal, focus error signal (FE signal), tracking error signal (TE signal) and the like. At this point, reading out of information is performed utilizing RF signal, and focusing control and tracking control are performed based on FE signal and TE signal.

A control portion 14 has a function to control whole operation of the optical pickup device 1. For example, the control portion 14 performs control of the laser diode driving circuit 15, control of the spherical aberration correcting mechanism 11, control of the actuator 12 which is described above, and the like.

Further, a thermistor 16 is arranged on a circuit board on which the laser diode 2, the laser diode driving circuit 15 and the like are mounted to control light output level of the laser diode 2 based on temperature information detected by this thermistor 16. Still further, the control portion 14 has a temperature recognition function to recognize temperature of the object lens 7 from the temperature information detected by the thermistor 16, and a temperature characteristics correction function to correct the temperature characteristics of the object lens from the recognized temperature of the object lens, to perform control correcting the temperature characteristics of the object lens in response to recognized temperature.

In this respect, about control of the spherical aberration correcting mechanism 11 that is one of control to correct the temperature characteristics of the object lens 7, it is possible that the control portion 14 performs it by receiving information from the signal processing portion 13. However, it is also possible that the control portion 14 performs it by recognize temperature of the object lens 7 from the temperature information of the thermistor 16 in response to recognized temperature. Also, it is possible to perform with combination of these such that a prescribed correction operation is performed and then, fine correction is performed utilizing a signal from the signal processing portion 13.

In order to perform signal reading out operation and signal recording operation of the signal recorded in the optical disc 20, it is necessary that shape of spot that is generated by irradiation of the laser light, is made in good state. In this respect, as a factor that gives bad effect to shape of the spot, aberration such as spherical aberration, coma aberration, and the like can be listed. In order to make the aberration not affect on shape of the spot, it is preferable to utilize the plastic lens that is easy to cast in an arbitrary desirable shape.

However, in the plastic lens, because an optical characteristics thereof varies drastically caused by variation of refractive index or shape of the lens in connection with the temperature variation, it has a weak point that above described aberration is generated, it is necessary to perform the correction of temperature characteristics in that temperature characteristics is corrected in response to temperature of the lens.

Above described degree of amount of aberration which is generated in light passing through the lens in response to ambient temperature variation in vicinity of the lens, is referred to as the temperature characteristics, and especially when the plastic lens is utilized, necessity to adjust the temperature characteristics is caused in response to variation of the ambient temperature. In order to adjust the temperature characteristics of the lens, by providing with a lens mechanism and a liquid crystal aberration correcting element for correcting the characteristics, and by adjusting these in response to temperature of the lens, the correction of temperature characteristics can be performed.

When this correction of temperature characteristics is performed, it is essential to recognize accurately temperature of the object lens 7. In the present embodiment, the thermistor 16 that is arranged to make control accuracy of light emission power of the laser diode 2 increased by detecting ambient temperature of the laser diode 2, is utilized for this purpose. That is, structure is employed in which temperature of the object lens 7 is recognized utilizing the thermistor 16 that is arranged on a circuit board on which the laser diode driving circuit 15 to drive the laser diode 2, is arranged.

Further, because the laser diode driving circuit 15 generates heat when driving of the system is begun, the temperature in vicinity of the thermistor is increased in combination with starting of the system operation, and after a predetermined time has gone by, the temperature reaches substantially a saturation temperature. As a result, difference of temperature which is detected by the thermistor 16 and actual temperature of the object lens 7 is large before the predetermined time has gone by, the difference converges gradually to a constant difference and the state arrives at saturation. As above described after the predetermined time has gone by, it is possible to obtain accurately temperature of the object lens 7 by performing a prescribed recognizing operation on the temperature information detected by the thermistor 16. That is, temperature of the object lens 7 can be recognized from the temperature information detected by the thermistor 16.

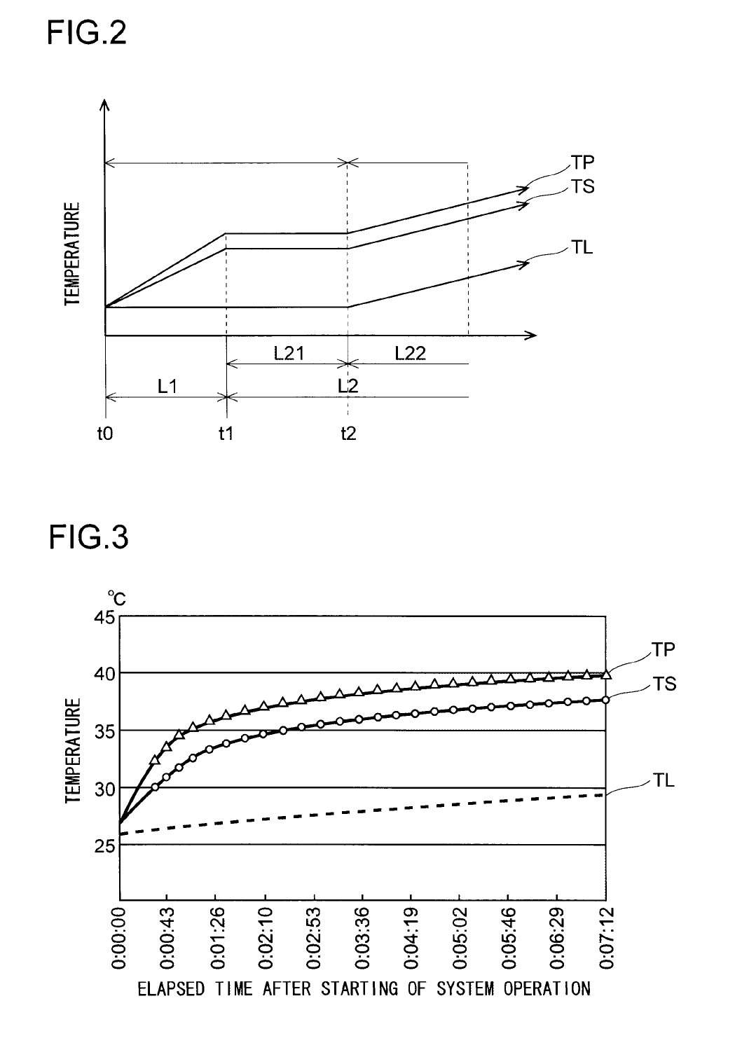

At this point, explanation will be given on relation between temperature detected by the thermistor 16 and temperature of the object lens 7 utilizing a schematic diagram to show a general outline of temperature variation shown in FIG. 2.

In a horizontal axis of the drawing, elapsed time after operation of the system is started, is shown and in a vertical axis of the drawing, temperature is shown. Further in the drawing, time point t0 when the system operation is started, time point t1 when a predetermined time L1 elapses, time point t2 when the ambient temperature varies, temperature TL of the object lens, temperature TS of the thermistor, and temperature TP of the heat generating parts at these time points, are shown with their relation and aspect of temperature variation.

As understandable by the drawing, from the time point t0 when the system operation is started to the time point t1 when the predetermined time L1 elapses, temperature TP of the heat generating parts increases violently. At the same time, temperature of the thermistor TS increases also violently in connection with temperature rising of the heat generating parts.

However, temperature TL of the object lens keeps substantially a constant value until the time point t2 when the ambient temperature keeps a constant value, after the time point t2 when the ambient temperature varies, it increases in connection with temperature rising of the vicinity parts. In this respect, because temperature TS of the thermistor also shows almost the same temperature rising curve at this time period, after the predetermined time L1 elapses, it is possible to recognize the temperature TL of the object lens from the temperature TS of the thermistor. That is, the temperature recognition operation is made possible.

As above described, at the time period L2 after a predetermined time elapsed from starting of the system operation, temperature of the object lens 7 can be recognized from the temperature information detected by the thermistor. In this respect, though a time period L21 in which the ambient temperature does not vary, and a time period L22 in which the ambient temperature varies, are conceivable in this time period L2, temperature of the object lens TL can be obtained accurately from temperature of the thermistor TS through the prescribed temperature recognition operation because a prescribed correlation can be observed between temperature of the thermistor TS and temperature of the object lens TL in both time periods L21 and L22.

As a result, according to the present embodiment, structure is employed in the optical pickup device 1 in which it is configured to includes a temperature recognition function to perform the temperature recognition operation that temperature of the object lens is recognized from the temperature information detected by the thermistor, a temperature characteristics correction function to correct the temperature characteristics of the lens from recognized temperature of the object lens, and in addition to these two functions, a temperature recognition operation waiting function to wait starting of the temperature recognition operation in a predetermined time period that is defined in advance, are included. For more detail, the structure is configured to include a function stopping the recognition operation for the predetermined time period from starting of drive of the optical pickup device, a function to permit starting of the temperature recognition operation after the predetermined time period elapses, and the temperature recognition operation waiting function to wait starting of the temperature recognition operation till the predetermined time period elapses, then, the temperature recognition operation is started to recognize temperature of the object lens after the predetermined time period elapses. That is, the predetermined time period L1 is a waiting time, and while the period the correction of temperature characteristics is not performed.

When driving of the optical pickup device is started, temperature of the thermistor becomes increased by heat generation of the heat generating parts such as the laser diode, the laser diode driving circuit, and the like, those become heated gradually in connection with starting of the system operation. According to this structure, the device is configured such that the correction of temperature characteristics of the object lens is not performed till the predetermined time period elapses, the prescribed temperature recognition operation is started to recognize temperature of the object lens and then the temperature characteristics correction for the object lens is started when the device reaches the saturation temperature and the device is made stable because the prescribed temperature recognition operation is started to recognize temperature of the object lens after the predetermined time period elapsed, by the temperature recognition operation waiting function, the device holds to wait for the predetermined time period that is defined in advance. As a result, correction of the temperature characteristics that varies in response to temperature of the object lens, is made possible to perform adequately, and it is preferable that optical pickup device in which the insufficient correction or the excessive correction is not generated, is realized.

Further, it is possible that structure is employed in which a function to measure variation rate of temperature that is detected by the thermistor, and a function to define in advance the variation rate of temperature to start the temperature recognition operation are included, the device is configured such that the variation rate of temperature detected by the thermistor is measured, and starting of the temperature recognition operation is permitted to recognize temperature of the object lens after confirmation that the rate of temperature variation becomes lower than variation rate to start the temperature recognition which is defined in advance. In structure by which time period till the rate of temperature variation detected by the thermistor becomes lower than the variation rate to start the temperature recognition defined in advance is defined as a temperature recognition operation waiting period, the prescribed temperature recognition operation is started to recognize temperature of the object lens after variation rate of temperature of the thermistor becomes lower than the variation rate to start the temperature recognition defined in advance, that is, after temperature of the thermistor substantially reaches the saturation temperature. As above described, due to the structure according to the present embodiment, it is preferable that the optical pickup device is provided in which the insufficient correction or the excessive correction is not generated and the adequate correction of temperature characteristics is made possible because the temperature recognition operation is not started for a predetermined time period that the variation rate of temperature detected by the thermistor becomes lower than the variation rate to start the temperature recognition, the prescribed temperature recognition operation is started to recognize temperature of the object lens, and then, the temperature characteristics correction for the object lens is started when the device reaches the saturation temperature and the device is made stable. As a result, it is preferable that the optical pickup device is realized in which the insufficient correction or the excessive correction is not generated, and stable temperature characteristics correction is made possible.

Still further, due to the structure according to the present embodiment, it is more preferable that the optical pickup device is provided in which the insufficient correction or the excessive correction is not generated and the adequate correction of temperature characteristics is made possible because even in a state where rate of the temperature variation of the thermistor becomes lower than the variation rate to start the temperature recognition defined in advance, the temperature recognition operation is not started and the correction of temperature characteristics is not performed if the predetermined time period defined in advance does not elapse, by the structure in that the temperature recognition operation waiting function as far as includes the function to measure the variation rate of temperature detected by the thermistor, the function not to start the temperature recognition operation until the rate of temperature variation becomes lower than the variation rate to start the temperature recognition defined in advance, and a function to hold waiting the temperature recognition operation for the predetermined time period defined in advance from starting of driving operation of the optical pickup device. As a result, it is preferable that the optical pickup device is realized in which the insufficient correction or the excessive correction is not generated, and more stable temperature characteristics correction is made possible.

As above described, the optical pickup device as far as includes the function to hold waiting the temperature recognition operation for the predetermined time period defined in advance from starting of driving operation of the optical pickup device, a temperature characteristics correction method can be adopted in which the temperature recognition operation is held to wait for the predetermined time period defined in advance from starting of driving operation of the optical pickup device, the temperature recognition operation is started to recognize temperature of the object lens after the predetermined time period has elapsed, and the correction of the temperature characteristics is started. Further, by this temperature characteristics correction method, it is preferable that the optical pickup device is provided in which the insufficient correction or the excessive correction is not generated and the adequate correction of temperature characteristics that varies in response to temperature of the object lens, is made possible because the correction of temperature characteristics of the object lens is not performed till the predetermined time period elapsed, the prescribed temperature recognition operation is started to recognize temperature of the object lens, and then, the temperature characteristics correction for the object lens is started when the device reaches the saturation temperature and the device is made stable. As a result, it is preferable that the temperature characteristics correction method for an object lens is realized in which the insufficient correction or the excessive correction is not generated, and stable temperature characteristics correction is made possible.

Further, in the optical pickup device that includes the function to measure the variation rate of temperature detected by the thermistor, and the function not to start the temperature recognition operation until the rate of temperature variation becomes lower than the variation rate to start the temperature recognition defined in advance, the temperature characteristics correction method can be adopted in that the prescribed temperature recognition operation is started to recognize temperature of the object lens, and the temperature characteristics correction for the object lens is started after variation rate of temperature of the thermistor becomes lower than the variation rate to start the temperature recognition defined in advance, that is, after temperature of the thermistor substantially reaches the saturation temperature. According to this temperature characteristics correction method, it is preferable that the optical pickup device is realized in which the insufficient correction or the excessive correction is not generated and the adequate correction of temperature characteristics is made possible.

Still further, in the optical pickup device that as far as includes the function to hold waiting the temperature recognition operation for the predetermined time period, and the function not to start the temperature recognition operation until the rate of temperature variation becomes lower than the variation rate to start the temperature recognition defined in advance, the temperature characteristics correction method can be adopted in that the temperature recognition operation is not started if the predetermined time period defined in advance does not elapse. According to this temperature characteristics correction method, it is more preferable that the temperature characteristics correction method of the object lens is realized in which the insufficient correction or the excessive correction is not generated and the stable correction of temperature characteristics is made possible because the operation is held to wait for a while temperature of the thermistor substantially reaches the saturation temperature even when rate of temperature variation of the thermistor becomes pretty small.

At this point in the temperature characteristics correction method, the variation rate to start the temperature recognition is set in about 1 degree C./30 seconds. This is because temperature of the thermistor that is raised about 8 degree C. in first two minutes (corresponding to 2 degree C./30 seconds) after starting of the system operation, is raised only about 2 degree C./2 minutes (corresponding to 0.5 degree C./30 seconds) after five minutes has elapsed from starting of the system operation when it substantially reaches the saturation temperature, as shown in FIG. 3, and it is conceivable that the variation rate to start the temperature recognition set in above described level, is a suitable criteria to sense coming closer to the saturation temperature. According to this structure, stable correction of the temperature characteristics is made possible in which the insufficient correction or the excessive correction is not generated without waste of time because the temperature recognition operation of the object lens is started and the correction of temperature characteristics is performed at an early time point when raise level of temperature becomes about 1 degree C./30 seconds and the system comes closer to substantial saturation state, it is conceivable that the system reaches the saturation temperature, though ambient temperature of vicinity where the thermistor is arranged is raised violently due to the heat generating parts such as the laser diode, the laser driving circuit, and the like which make heat violently after starting of the system operation of the optical pickup device.

It is adequate that the predetermined time period L1 which is set through the temperature recognition operation waiting function, is about a level of five minutes because the system has substantially reached the saturation temperature in about five minutes after starting of the system operation. Further, even when the rate of temperature variation of the thermistor becomes lower than 1 degree C./30 seconds, the predetermined time period L1, five minutes in this case, is made the waiting time while temperature of the object lens is not recognized, and the temperature of the object lens is recognized and the prescribed correction of temperature characteristics is performed after five minutes has elapsed, therefore, the correction of temperature characteristics of the object lens, is made proper and possible in which the insufficient correction or the excessive correction is not generated.

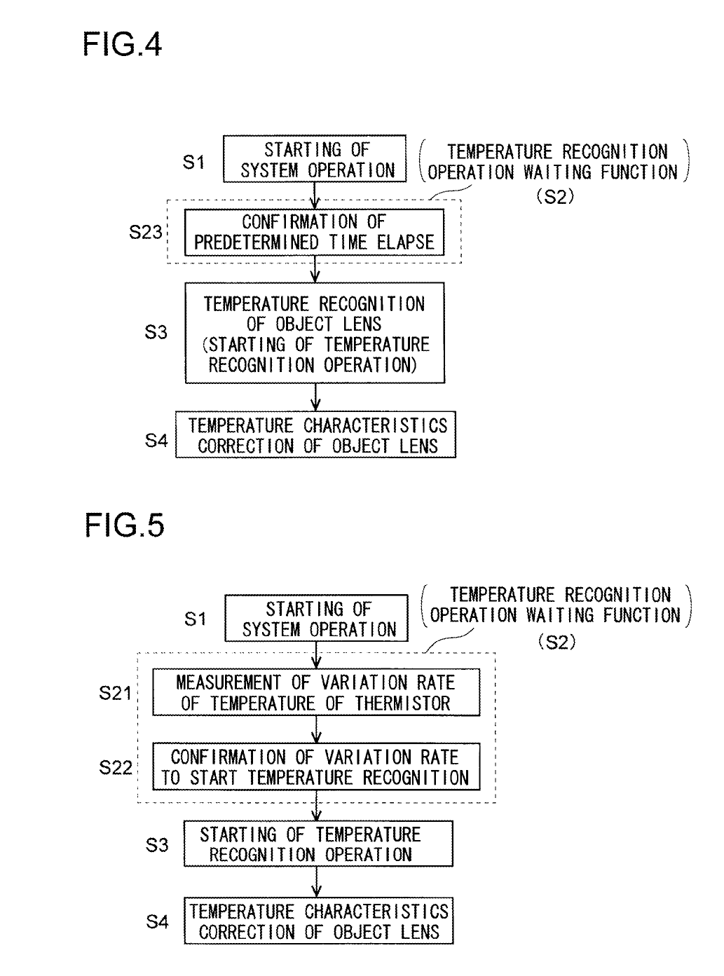

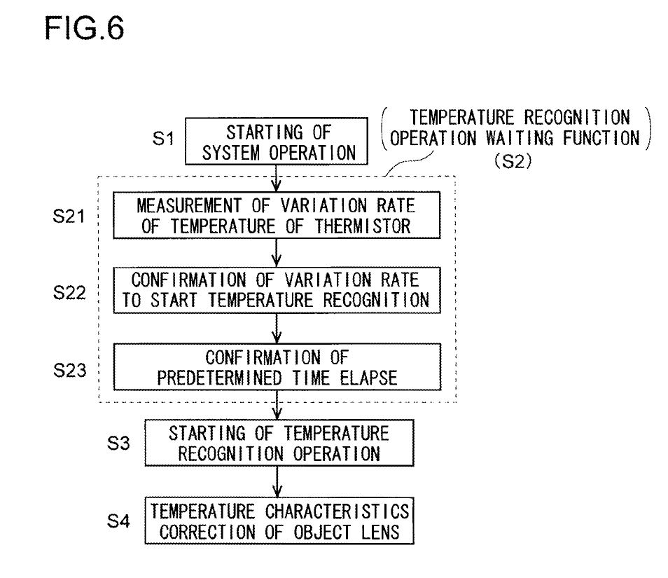

Next, further explanation will be given about operating processes of the temperature characteristics correction method with reference to a flowchart shown in FIG. 4, FIG. 5 and FIG. 6.

The flowchart of a first embodiment of the present invention shown in FIG. 4 shows an operating processes utilizing the temperature recognition operation waiting function (S2) in which the temperature recognition operation (S3) is not permitted till it is confirmed that the predetermined time period has elapsed. In this operating processes, correction of temperature characteristics of the object lens (S4) is performed such that it is confirmed that the predetermined time period has elapsed (S23) after starting of the system operation (S1), temperature recognition operation (S3) is started after the predetermined time period defined in advance has elapsed, and then temperature of the object lens is recognized.

A flowchart of a second embodiment of the present invention shown in FIG. 5, shows an operating processes utilizing the temperature recognition operation waiting function (S2) in which the function to measure the rate of temperature variation of the thermistor (S21), and a function to define in advance the rate of temperature variation to start the temperature recognition operation (S22), are included, and temperature recognition operation waiting function (S2) is performed such that starting of the temperature recognition operation (S3) is not permitted after it is confirmed that the detected rate of variation becomes lower than the variation rate to start the temperature recognition defined in advance. In this operating processes, correction of temperature characteristics of the object lens (S4) is performed such that after starting of the system operation (S1), the rate of temperature variation of the thermistor is measured (S21), the variation rate to start the temperature recognition is confirmed (S22), and then the temperature recognition operation (S3) is started to recognize temperature of the object lens after the detected rate of variation becomes lower than the variation rate to start the temperature recognition.

A flowchart of a third embodiment of the present invention shown in FIG. 6, shows an operating processes utilizing the temperature recognition operation waiting function (S2) in which the function to measure the rate of temperature variation of the thermistor (S21), a function to define in advance the rate of temperature variation to start the temperature recognition operation(S22), are included, and further a function to hold waiting the temperature recognition operation for a predetermined time period defined in advance (S23), and temperature recognition operation waiting function (S2) is performed such that starting of the temperature recognition operation (S3) is not permitted after it is confirmed that the detected rate of variation becomes lower than the variation rate to start the temperature recognition defined in advance, and further it is confirmed that the predetermined time period has elapsed. In this operating processes, correction of temperature characteristics of the object lens (S4) is performed such that after starting of the system operation (S1), the rate of temperature variation of the thermistor is measured (S21), the variation rate to start the temperature recognition is confirmed (S22), and then the temperature recognition operation (S3) is started to recognize temperature of the object lens after the detected rate of variation becomes lower than the variation rate to start the temperature recognition, and it is confirmed that the predetermined time period defined in advance has elapsed (S23).

All of each temperature characteristics correction method in the first, second and third embodiment above described, includes the temperature recognition operation waiting function (S2) to hold waiting the temperature recognition operation for the predetermined time period defined in advance, and the temperature recognition operation to recognize temperature of the object lens is started about a time point when temperature information detected by the thermistor and temperature of the object lens reach the saturation temperature and the system becomes stable, then temperature of the object lens is recognized accurately, therefore, they are the methods to make proper correction of temperature characteristics possible.

Till now, explanation were given about the optical pickup device and the temperature characteristics correction method for the object lens to recognize temperature of the object lens utilizing the thermistor that is arranged on the circuit board on which the laser diode driving circuit is mounted. Structure may be employed in which temperature sensor to recognize temperature of the object lens is a temperature sensor to detect temperature of other heat generating parts. Even in such a case, it is preferable that structure includes the temperature recognition operation waiting function to hold waiting the temperature recognition operation for the predetermined time period because the heat generating parts generate heat violently just after starting of the system operation. According to the optical pickup device and the temperature characteristics correction method for the object lens with this kind of structure, the optical pickup device and the temperature characteristics correction method can be realized in which the insufficient correction or the excessive correction is not generated and proper correction of temperature characteristics is made possible.

As above described, in the optical pickup device according to the present invention, structure is employed in which the prescribed temperature recognition operation is performed on temperature information detected by the thermistor, temperature of the object lens is recognized, and the temperature characteristics is corrected, and at the same time, the temperature recognition operation waiting function to hold waiting the temperature recognition operation, therefore, the temperature recognition operation to recognize temperature of the object lens can be started about a time point when temperature information detected by the thermistor and temperature of the object lens reach the saturation temperature and the system becomes stable, it is made possible that temperature of the object lens is recognized accurately, and the correction of temperature characteristics which varies in response to temperature of the object lens, and the optical pickup device can be realized in which the insufficient correction or the excessive correction is not generated.

Further, in the optical pickup device according to the present invention, structure is employed in which the temperature recognition operation waiting function is a function to hold waiting operation for the predetermined time period defined in advance from starting of the system operation, temperature recognition operation is started to recognize temperature of the object lens after the predetermined time has elapsed, therefore, it is configured such that the prescribed temperature recognition operation is started to recognize temperature of the object lens about a time point when temperature reaches the saturation temperature and the system becomes stable, and then, the correction of temperature characteristics of the object lens is started, it is made possible that the correction of temperature characteristics which varies in response to temperature of the object lens, and the optical pickup device can be realized in which the insufficient correction or the excessive correction is not generated.

Still further, in the optical pickup device according to the present invention, structure is employed in which the temperature recognition operation waiting function is a function to hold waiting operation till the rate of temperature variation of the thermistor becomes lower than the variation rate to start the temperature recognition defined in advance, after it is confirmed that rate of temperature variation of the thermistor becomes lower than the variation rate to start the temperature recognition defined in advance, starting of the temperature recognition operation is permitted to recognize temperature of the object lens, therefore, it is configured such that the prescribed temperature recognition operation is started to recognize temperature of the object lens after the rate of temperature variation of the thermistor becomes lower than the variation rate to start the temperature recognition defined in advance, that is, temperature of the thermistor reaches the saturation temperature. As a result, the optical pickup device can be realized in which the prescribed temperature recognition operation is started to recognize temperature of the object lens about a time point when temperature reaches the saturation temperature and the system becomes stable, and then, the correction of temperature characteristics of the object lens is started, the insufficient correction or the excessive correction is not generated, and the proper correction of temperature characteristics is made possible.

Still further, in the optical pickup device according to the present invention, structure is employed in which the both of the function to hold waiting the temperature recognition operation for the predetermined time period, and the function not to start the temperature recognition operation until the rate of temperature variation becomes lower than the variation rate to start the temperature recognition defined in advance, are included, even when the rate of temperature variation becomes lower than the variation rate to start the temperature recognition defined in advance, the temperature recognition operation is not started and the correction of temperature characteristics is not performed before the predetermined time period defined in advance has not elapsed. As a result, the optical pickup device can be realized in which the temperature recognition operation is not started and the correction of temperature characteristics is not performed before the predetermined time period has elapsed, even though in a state where rate of temperature variation of the thermistor becomes lower than the variation rate to start the temperature recognition defined in advance, the insufficient correction or the excessive correction is not generated and the stable correction of temperature characteristics is made possible.

In the temperature characteristics correction method for the object lens according to the present invention, structure is employed in which the system is held to wait for the predetermined time period defined in advance from starting of the system operation, the temperature recognition operation is started after the predetermined time period has elapsed, temperature of the object lens is recognized, and then the correction of the temperature characteristics is performed, when the temperature recognition operation is performed on the temperature information detected by the thermistor, temperature of the object lens is recognized to correct the temperature characteristics of the lens, therefore, the prescribed temperature recognition operation can be started about a time point when temperature of the object lens reach the saturation temperature, and temperature of the object lens is recognized accurately. As a result, the correction of temperature characteristics which varies in response to temperature of the object lens, and the temperature characteristics correction method for the object lens can be realized in which the insufficient correction or the excessive correction is not generated.

According to the structure, variation rate of temperature detected by the thermistor is measured, the temperature recognition operation is started after the rate of temperature variation becomes lower than the variation rate to start the temperature recognition defined in advance, therefore, the temperature characteristics correction method can be realized in which the prescribed temperature recognition operation is started about the time point when temperature of the object lens reaches the saturation temperature and becomes stable, the insufficient correction or the excessive correction is not generated, and the temperature characteristics correction for the object lens is performed properly.

Further, the structure is employed in which starting of the temperature recognition operation is not permitted and correction of temperature characteristics is not performed even in the state where the rate of temperature variation measured through the thermistor becomes lower than the variation rate to start the temperature recognition defined in advance, if the predetermined time period has not elapsed, therefore, the temperature characteristics correction method in which the insufficient correction or the excessive correction is not generated and stable correction of temperature characteristics for the object lens is made possible, can be realized.

As above described, according to the present invention, it is made possible that temperature of the object lens is accurately recognized, and the proper correction of temperature characteristics is performed, as a result, the temperature characteristics correction method for the object lens can be realized in which the insufficient correction or the excessive correction is not generated and the temperature characteristics of the object lens is corrected properly.

### USABILITY IN INDUSTRIAL FIELD

Because of this, by the optical pickup device and the temperature characteristics correction method for the object lens according to the present invention, even in a case where the system is composed by a plurality of parts of the heat generating parts and not heat generating parts that have different temperature characteristics respectively, temperature of both of the heat generating parts and the not heat generating parts can be recognized utilizing only one temperature sensor, as a result, the device and the method can be applied to the optical pickup device that includes the laser diode which is a heat generating parts, and the object lens which is a not heat generating parts.

### EXPLANATION OF REFERENCE DESIGNATOR

1 optical pickup device
2 laser diode
7 object lens
14 control portion
15 laser diode driving circuit
16 thermistor
L1 predetermined time period (temperature recognition operation waiting time period)
TL temperature of object lens
TS temperature of thermistor
TP temperature of heat generating parts

What is claimed is:

1. An optical pickup device comprising:
a circuit board;
a laser diode, a laser diode driving circuit and a thermistor that are mounted on the circuit board; and
a control portion that has a control function to perform recording or reproducing of data by irradiating an optical disc with laser light and controlling light output of the laser diode based on temperature information detected by the thermistor, wherein
the optical pickup device has
a temperature recognition function which performs a temperature recognition operation to recognize temperature of the object lens from the temperature information detected by the thermistor,
a temperature characteristics correction function to correct temperature characteristics of the lens from the recognized temperature of the object lens, and a temperature recognition operation waiting function not to start the temperature recognition operation for a predetermined time period defined in advance.

2. The optical pickup device according to claim 1, wherein
the predetermined time period is a time period that is defined in advance from starting of the system operation of the optical pickup device, and the temperature recognition operation waiting function includes a function to hold waiting the temperature recognition operation for the predetermined time period, and a function to permit starting of the temperature recognition operation after the predetermined time period has elapsed, and the temperature recognition operation waiting function is performed such that the temperature recognition operation is held waiting until it is confirmed that the predetermined time period has elapsed.

3. The optical pickup device according to claim 1, wherein
the predetermined time period is a time period that is variation rate of temperature detected by the thermistor becomes lower than variation rate to start the temperature recognition defined in advance, and the temperature recognition operation waiting function includes a function to measure variation rate of temperature detected by the thermistor, and a function to define in advance variation rate to start the temperature recognition operation, and wherein
the temperature recognition operation waiting function is performed such that the temperature recognition operation is not started till the measured rate of the temperature variation becomes lower than the variation rate to start the temperature recognition defined in advance.

4. The optical pickup device according to claim 1, wherein
the temperature recognition operation waiting function includes a function to measure variation rate of temperature detected by the thermistor, a function not to start the temperature recognition operation till the measured variation rate of temperature becomes lower than variation rate to start the temperature recognition operation defined in advance, and a function to hold waiting the temperature recognition operation for a predetermined time period defined in advance from starting of the system operation of the optical pickup device, and wherein the predetermined time period is a time period that the rate of temperature variation becomes lower than variation rate to start the temperature recognition defined in advance, and at the same time the predetermined time period defined in advance has lapsed.

5. A temperature characteristics correction method for an object lens applicable to an optical pickup device comprising:
a circuit board;
a laser diode, a laser diode driving circuit and a thermistor that are mounted on the circuit board; and
a control portion that has a control function to perform recording or reproducing of data by irradiating an optical disc with laser light and controlling light output of the laser diode based on temperature information detected by the thermistor, the temperature characteristics correction method includes:
a temperature recognition function which performs a temperature recognition operation to recognize temperature of the object lens from the temperature information detected by the thermistor,
a temperature characteristics correction function to correct temperature characteristics of the lens from the recognized temperature of the object lens, and a temperature recognition operation waiting function not to start the temperature recognition operation for a predetermined time period defined in advance, wherein
the method is performed such that
the temperature recognition operation is held waiting for the predetermined time period defined in advance from starting of the system operation of the optical pickup device, and
the temperature recognition operation is started after the predetermined time period has lapsed.

6. A temperature characteristics correction method for an object lens applicable to an optical pickup device comprising:
a circuit board;
a laser diode, a laser diode driving circuit and a thermistor that are mounted on the circuit board; and
a control portion that has a control function to perform recording or reproducing of data by irradiating an optical disc with laser light and controlling light output of the laser diode based on temperature information detected by the thermistor, the temperature characteristics correction method includes:
a temperature recognition function which performs a temperature recognition operation to recognize temperature of the object lens from the temperature information detected by the thermistor, and
a temperature characteristics correction function to correct temperature characteristics of the lens from recognized temperature of the object lens, and the temperature characteristics correction method further includes:
a temperature recognition operation waiting function having
a function to measure variation rate of temperature detected by the thermistor and
a function to define in advance rate of temperature variation to start the temperature recognition operation, wherein
the method is performed such that the temperature recognition operation is started after that rate of temperature variation detected by the thermistor becomes lower than the rate of temperature variation to start the temperature recognition operation defined in advance, is detected.

7. The temperature characteristics correction method according to claim 6, wherein
the temperature recognition operation waiting function further includes a function not to start the temperature recognition operation for a predetermined time period defined in advance, and wherein
the method is performed such that
the temperature recognition operation is held waiting for the predetermined time period defined in advance from starting of system operation of the pickup device, starting of the temperature recognition operation is permitted after the predetermined time period has elapsed, and
the temperature recognition operation is not performed within the predetermined time period defined in advance even in a state where the rate of temperature variation becomes lower than the variation rate to start the temperature recognition defined in advance.

8. The temperature characteristics correction method according to claim 6, wherein the variation rate to start the temperature recognition is 1 degree C./30 seconds.
